(19) United States
(12) Patent Application Publication
(10) Pub. No.: US 2024/0321222 A1
(43) Pub. Date: Sep. 26, 2024

(54) DISPLAY PANEL, METHOD FOR DRIVING THE SAME AND DISPLAY DEVICE

(71) Applicant: Wuhan Tianma Microelectronics Co., Ltd., Wuhan (CN)

(72) Inventors: Ye HUANG, Wuhan (CN); Yangxi LIU, Wuhan (CN); Chenghui HUANG, Wuhan (CN); Jun LI, Wuhan (CN)

(21) Appl. No.: 18/735,227

(22) Filed: Jun. 6, 2024

(30) Foreign Application Priority Data
Jun. 8, 2023 (CN) 202310684352.2

(51) Int. Cl. G09G 3/3275

(52) U.S. Cl. CPC G09G 3/3275; G09G 2310/0297; G09G 2310/08; G09G 2320/0209

(57) ABSTRACT

A display panel, a method for driving a display panel and a display device. The display panel includes a demultiplexer, a data terminal, data lines, and sub-pixels, the demultiplexer includes an input terminal connected to the data terminal. The demultiplexer includes switches connected to data lines, which are connected to the sub-pixels including a first sub-pixel, a second sub-pixel, and a third sub-pixel that emit lights of different colors. The method includes: supplying, by the data terminal, data signals to the input terminal of the demultiplexer, and turning on the switches with predetermined time durations respectively to input the data signals to the data lines, the data signals including a first data signal corresponding to the first sub-pixel, and a turned-on time duration of the switch corresponding to a time period in which the first data signal is supplied to the input terminal of the demultiplexer being the longest.

### CROSS-REFERENCE TO RELATED APPLICATIONS

The present application claims priority to Chinese Patent Application No. 202310684352.2, filed on Jun. 8, 2023, the content of which is incorporated herein by reference in its entirety.

### TECHNICAL FIELD

The present disclosure relates to the technical field of display, and in particular, to a display panel, a method for driving a display panel, and a display device.

### BACKGROUND

Organic light-emitting diode (OLED) has self-luminous characteristics, and is used in the display field. OLED display panels are light and thin, and have high brightness, low power consumption, fast response, high definition, good flexibility, high luminous efficiency, and can meet new needs of consumers for display technology. Currently, the display panel suffers from a crosstalk issue between signal lines, which affects the display effect.

### SUMMARY

Embodiments of the present disclosure provide display panel, a method for driving a display panel, and a display device.

In an aspect, a method for driving a display device is provided. The display panel includes a demultiplexer, a data terminal, data lines, and sub-pixels, the demultiplexer includes an input terminal connected to the data terminal and output terminals connected to n data lines of the data lines respectively, n is an integer and n≥2, the demultiplexer further includes n switches, each switch is connected between the input terminal and one of the output terminals and connected to a corresponding one data line of the n data lines, the data lines extend in a first direction and are connected to the sub-pixels, and the sub-pixels include a first sub-pixel, a second sub-pixel, and a third sub-pixel that emit lights of different colors. The method includes: supplying, by the data terminal, data signals to the input terminal of the demultiplexer, and turning on the switches for predetermined time durations respectively to input the data signals to the n data lines. The data signals include a first data signal corresponding to the first sub-pixel, a second data signal corresponding to the second sub-pixel, and a third data signal corresponding to the third sub-pixel; and a turned-on time duration of the switch, which corresponds to a time period in which the first data signal is supplied to the input terminal of the demultiplexer, is the longest.

In another aspect of the present disclosure, a display panel is provided. The display panel is driven by a driving method. The display panel includes a demultiplexer, a data terminal, data lines, and sub-pixels, the demultiplexer includes an input terminal connected to the data terminal and output terminals connected to n data lines of the data lines respectively, n is an integer and n≥2, the demultiplexer further includes n switches, each switch is connected between the input terminal and one of the output terminals and connected to a corresponding one data line of the n data lines, the data lines extend in a first direction and are connected to the sub-pixels, and the sub-pixels include a first sub-pixel, a second sub-pixel, and a third sub-pixel that emit lights of different colors. The method includes: supplying, by the data terminal, data signals to the input terminal of the demultiplexer, and turning on the switches for predetermined time durations respectively to input the data signals to the n data lines. The data signals include a first data signal corresponding to the first sub-pixel, a second data signal corresponding to the second sub-pixel, and a third data signal corresponding to the third sub-pixel; and a turned-on time duration of the switch, which corresponds to a time period in which the first data signal is supplied to the input terminal of the demultiplexer, is the longest.

In yet another aspect of the present disclosure, a display device is provided. The display device includes a display panel. The display panel includes a demultiplexer, a data terminal, data lines, and sub-pixels, the demultiplexer includes an input terminal connected to the data terminal and output terminals connected to n data lines of the data lines respectively, n is an integer and n≥2, the demultiplexer further includes n switches, each switch is connected between the input terminal and one of the output terminals and connected to a corresponding one data line of the n data lines, the data lines extend in a first direction and are connected to the sub-pixels, and the sub-pixels include a first sub-pixel, a second sub-pixel, and a third sub-pixel that emit lights of different colors. The method includes: supplying, by the data terminal, data signals to the input terminal of the demultiplexer, and turning on the switches for predetermined time durations respectively to input the data signals to the n data lines. The data signals include a first data signal corresponding to the first sub-pixel, a second data signal corresponding to the second sub-pixel, and a third data signal corresponding to the third sub-pixel; and a turned-on time duration of the switch, which corresponds to a time period in which the first data signal is supplied to the input terminal of the demultiplexer, is the longest.

The display panel, the method for driving the display panel and the display device provided by embodiments of the present disclosure have the following technical effects. When driving the display panel to operate, the turned-on time duration of the switch corresponding to a time period in which the first data signal is supplied to the input terminal of the demultiplexer is the longest. The first data signal corresponds to the first sub-pixel. With a longer turned-on time duration of the switch, the data line is charged more sufficiently, and the voltage value of the charged data line can be closer to the desired of the first data signal, so the voltage required by the dark state of the first sub-pixel can be reduced. When the first sub-pixel among the three sub-pixels emitting lights of different colors has a highest light-emitting efficiency, the dark-state voltage of the display panel depends on the dark-state voltage of the first sub-pixel. The dark-state voltage of the display panel can be reduced by the driving method provided by embodiments of the present disclosure. With the dark-state voltage of the display panel being reduced, when the sub-pixel driven by the data line is switched to the black greyscale (the minimum greyscale), the voltage change amount on the data line is reduced, and therefore, the voltage fluctuation on other signal lines (such as the power supply line) caused by coupling from the data line is reduced. In this way, when the switch connected to the data line is turned off and the data line is accordingly in a floating state, the affecting of the voltage fluctuation on the power supply line on the voltage on the data line is also reduced, thereby reducing the line-to-line crosstalk between signal lines and improving the display effect.

### BRIEF DESCRIPTION OF DRAWINGS

In order to better illustrate the technical solutions in the embodiments of the present disclosure, the accompanying drawings used in the description of the embodiments will be briefly introduced below. It should be noted that, the accompanying drawings in the following description are only some embodiments of the present disclosure, and other drawings can be obtained by those of ordinary skill in the art from the provided drawings without creative efforts.

FIG. 1 is a schematic diagram of a display panel according to one or more embodiments of the present disclosure.

FIG. 2 is a flowchart of a method for driving a display panel according to one or more embodiments of the present disclosure.

FIG. 3 is a schematic diagram of another display panel according to one or more embodiments of the present disclosure.

FIG. 4 is a timing diagram of a control signal of a switch according to one or more embodiments of the present disclosure.

FIG. 5 is a schematic diagram of yet another display panel according to one or more embodiments of the present disclosure.

FIG. 6 is an operation timing diagram of a demultiplexer in FIG. 5.

FIG. 7 is a schematic diagram of yet another display panel according to one or more embodiments of the present disclosure.

FIG. 8 is an operation timing diagram of a demultiplexer in FIG. 7.

FIG. 9 is a schematic diagram of yet another display panel according to one or more embodiments of the present disclosure.

FIG. 10 is an operation timing diagram of a demultiplexer in FIG. 9.

FIG. 11 is a timing diagram of another display panel according to one or more embodiments of the present disclosure.

FIG. 12 is a schematic diagram of a display device according to one or more embodiments of the present disclosure.

### DESCRIPTION OF EMBODIMENTS

In order to better illustrate the objectives, features and advantages of the present disclosure, the present disclosure is further described with reference to accompanying drawings and various embodiments hereinafter. It should be noted that, the described embodiments are merely exemplary embodiments of the present disclosure, which shall not be interpreted as providing limitations to the present disclosure. All other embodiments obtained by those skilled in the art without creative efforts according to the embodiments of the present disclosure are within the scope of the present disclosure.

The terms used in the embodiments of the present disclosure are merely for the purpose of describing particular embodiments but not intended to limit the present disclosure. Unless otherwise noted in the context, the singular form expressions “a”, “an”, “the” and “said” used in the embodiments and appended claims of the present disclosure are also intended to represent plural form expressions thereof.

Conventionally, data lines are connected to data terminals through demultiplexers, and one demultiplexer is connected to at least two data lines. When being turned on, a switch in the demultiplexer connected to the data line connects the data line to the data terminal. With the connection by the switch, the data terminal transmits a data signal to the data line. When the switch connected to the data line is turned off, the data line is in a floating state, at this time, a voltage signal on the data line in the floating state is easily affected by coupling and fluctuates. In this case, if a display region is further provided with a power supply line that extends in a same direction as the data line, there exists a large coupling effect between the power supply line and the data line. When a sub-pixel driven by the data line is switched to a black greyscale (that is, switched to a greyscale 0), the voltage change on the data line will cause a voltage change on the power supply line, and the change on the power supply will further affect the voltage on the data line. When the switch is turned off and the data line is in the floating state, the voltage on the data line is likely affected by coupling and fluctuates like the voltage on the power supply line. The coupling effect between the data line and the power supply line is referred to as a line-to-line crosstalk. The line-to-line crosstalk affects the data voltage, and thus affects the display effect. The display panel is further provided with scan lines crossing the data lines, and there also exists the line-to-line crosstalk between the scan lines and the data lines.

To address the above problem, embodiments of the present disclosure provide a method for driving a display panel. The data signals corresponding to sub-pixels emitting different colors of light are designed to have different charging time durations. A dark-state voltage of the display panel may be affected by a first sub-pixel, and the charging time duration of a first data signal corresponding to the first sub-pixel is the longest. In this way, the voltage value of the first data signal inputted to the data line can be increased, and the first data signal on the data line can reach the target voltage, thereby reducing the dark-state voltage of the display panel. Since all sub-pixels in the display panel have a same dark-state voltage, with the reduced dark-state voltage, the voltage change amount on the data line is reduced when the sub-pixel connected to the data line is switched to the black greyscale, and the voltage fluctuation on other signal lines (for example, the power supply line) caused by the data line is reduced accordingly. As a result, the affecting of other signal lines to the voltage on the data line is also reduced, thereby reducing the crosstalk between the data line and other signal lines.

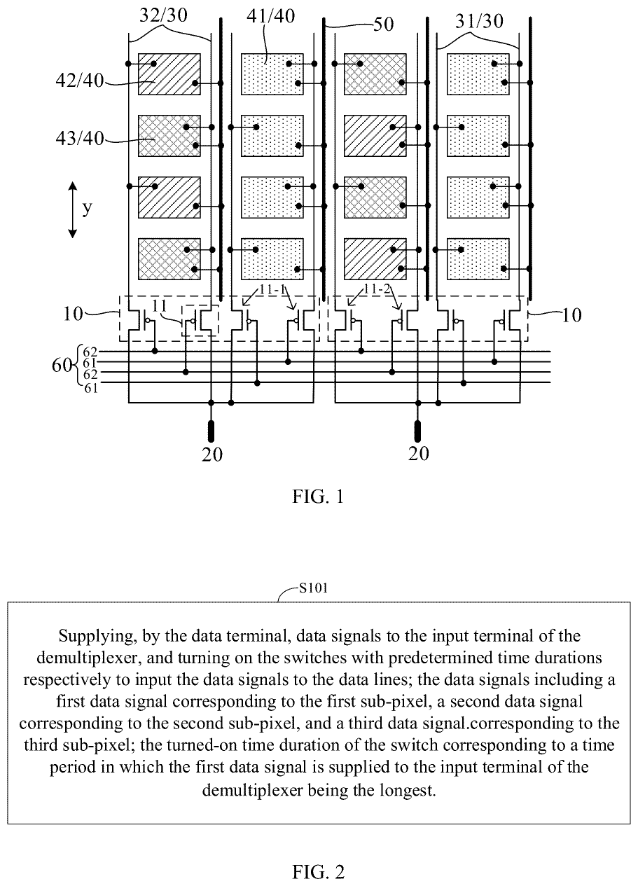

FIG. 1 is a schematic diagram of a display panel according to one or more embodiments of the present disclosure. As shown in FIG. 1, the display panel includes demultiplexers 10, data terminals 20, data lines 30, and sub-pixels 40. The demultiplexer 10 includes an input terminal connected to the data terminal 20, and output terminals connected to n data lines 30 respectively, where n is an integer and greater than or equal to 2. The demultiplexer 10 includes n switches 11, and each switch 11 is connected between the input terminal and the corresponding output terminal. Each switch 11 is connected to one corresponding data line 30. The switch 11 includes a transistor. The type of the transistor in the switch 11 is not limited in the present disclosure. The data line 30 extends in a first direction y and is connected to multiple sub-pixels 40. The sub-pixels 40 include a first sub-pixel 41, a second sub-pixel 42, and a third sub-pixel 43 that emit light of colors different from each other. The sub-pixel 40 includes a light-emitting element and a pixel circuit. The pixel circuit drives the light-emitting element to emit light. The light-emitting element may be an organic light-emitting element. In the example embodiment shown in FIG. 1, n=4, that is, the output terminals of one demultiplexer 10 are connected to four data lines 30. The number of the switches 11 in the demultiplexer 10 is equal to the number of the data lines 30 connected to the demultiplexer 10. The arrangement of the first sub-pixel 41, the second sub-pixel 42, and the third sub-pixel 43 in FIG. 1 is for illustration, and does not limit the present disclosure. The switch 11 in FIG. 1 is a P type transistor for illustration, and the following embodiments are described with the switch 11 being the P type transistor as an example. Alternatively, the switch 11 may be an N type transistor.

The data terminal 20 is configured to supply a data signal to the data line 30 through the demultiplexer 10. When the switch 11 connected to the data line 30 is in the turned-on state, the data terminal 20 is connected to the data line 30, and the data line 30 is charged, so that the data signal is inputted to the data line 30. The turned-on time duration of the switch 11 is equal to the charging time duration of the data line 30. During the display driving process, the n switches 11 in one demultiplexer 10 is turned on sequentially, and thus the n data lines 30 are charged sequentially. That is, the n switches 11 in one demultiplexer 10 is turned on in a time division manner.

FIG. 2 is a flowchart of a method for driving a display panel according to one or more embodiments of the present disclosure. As shown in FIG. 2, the driving method includes a step S101. In step S101, data signals are supplied to the input terminal of the demultiplexer 10 from the data terminal 20, and respective switches 11 are turned on for a predetermined time duration respectively, so that the data signals are inputted to the respective data lines 30 respectively. The data signals include a first data signal corresponding to the first sub-pixel 41, a second data signal corresponding to the second sub-pixel 42, and a third data signal corresponding to the third sub-pixel 43. A time period in which the first data signal is supplied to the input terminal of the demultiplexer 10 and the turned-on time duration of the corresponding switch 11 is the longest. The predetermined time duration refers to a time duration, which is determined in advance for driving the display panel to display, of the time duration the switch 11 being in the turned-on state once. For the time period in which the first data signal is inputted to the data line 30 from the data terminal 20, the turned-on time duration of the corresponding switch 11 is t₀₁. For the time period in which the second data signal is inputted to the data line 30 from the data terminal 20, the turned-on time duration of the corresponding switch 11 is t₀₂. For the time period in which the third data signal is inputted to the data line 30 from the data terminal 20, the turned-on time duration of the corresponding switch 11 is t₀₃. The turned-on time duration t₀₁ is longer than the turned-on time duration t₀₂, and the turned-on time duration t₀₁ is longer than the turned-on time duration t₀₃. That is, the turned-on time duration of the switch 11 connected to a data line 30, to which the data signal required by the first sub-pixel 41 is inputted, is the longest.

It should be noted that when the display panel is driven to display, each data line 30 is charged for a limited time duration, and an actual value of the voltage on the charged data line 30 may be less than the desired data voltage. The turned-on time duration of the switch 11 is longer, the data line 30 is charged more sufficiently, and the voltage value of the data signal inputted to the data line 30 is closer to the desired data voltage. In embodiments of the present disclosure, the turned-on time duration of the switch 11 corresponding to the time period in which the first data signal is inputted is the longest, and the input of the data voltage required by the light emitting of the first sub-pixel 41 is more sufficient.

The first sub-pixel 41, the second sub-pixel 42, and the third sub-pixel 43 in the display panel are different from each other in emission color and emission efficiency. The greater the emission efficiency of the sub-pixel 40 is, the greater the voltage required by the dark state displaying of the sub-pixel 40 is. However, a uniform dark-state voltage needs to be set for the first sub-pixel 41, the second sub-pixel 42, and the third sub-pixel 43 in the display panel. Therefore, this dark-state voltage is generally determined by the sub-pixel 40 having the greatest emission efficiency. In embodiments of the present disclosure, the first sub-pixel 41 has the greatest emission efficiency among the three colors of sub-pixels 40, so the dark-state voltage of the display panel is determined by the voltage required by the dark state displaying of the first sub-pixel 41. In some embodiments, the voltage required by the dark state displaying of the green sub-pixel is greatest among those of the red, blue and green sub-pixels, so the dark-state voltage of the green sub-pixel is taken as the dark-state voltage of the display panel. Herein, the first sub-pixel 41 is the green sub-pixel, one of the second sub-pixel 42 and the third sub-pixel 43 is the red sub-pixel, and the other one of the second sub-pixel 42 and the third sub-pixel 43 is the blue sub-pixel.

Conventionally, the charging-discharging time duration of a capacitor may be characterized by the following formula.

$${V}_{t} = {V}_{0} + ( {V}_{1} - {V}_{0} ) * [ 1 - exp ( - t / RC ) ] .$$

Vₜ is the target voltage, V₀ is the initial voltage, V₁ is the final voltage (that is, the anticipated charging voltage), R is the resistance of the signal line, C is the capacitance, and t is the charging time duration. In embodiments of the present disclosure, after the switch 11 is turned on and the data terminal 20 is connected to the data line 30, the process of inputting the data signal to the data line 30 is considered as a process of charging a wire capacitor, and can be characterized by the capacitance charging-discharging formula. Vₜ may be considered as the voltage value of the data signal actually inputted to the data line 30, V₁ is the dark-state voltage, V₀ is the initial voltage of the data line 30, and t is the charging time duration of the charging process of inputting the data signal to the data line 30. During the process of charging the data line 30, if Vₜ is fixed/constant, the dark-state voltage Vₜ may be reduced with the charging time duration t being increased. That means, by increasing the charging time duration for inputting the data signal to the data line 30, the voltage required by the sub-pixel for displaying the dark state can be reduced. In embodiments of the present disclosure, it is arranged that when the first data signal is supplied to the input terminal of the demultiplexer 10, the turned-on time duration of the switch 11 corresponding to the first data signal is the longest. In this way, the voltage required by the first sub-pixel 41 for switching to the dark state is reduced.

Embodiments of the present disclosure provide a method for driving a display panel, and the driving method is applied to a display panel in which the data line 30 is charged by the data terminal 20 through the demultiplexer 10. With the demultiplexer 10, the number of the data terminals 20 required by the display panel is reduced, and the number of pins of a display driving chip can be reduced accordingly, thereby reducing the manufacturing cost of the display driving chip. When the display panel is driven to operate, the turned-on time duration of the switch 11 corresponding to the time period in which the first data signal is supplied to the input terminal of the demultiplexer 10 is the longest. The first data signal corresponds to the first sub-pixel 41. The longer the turned-on time duration of the switch 11 makes the data line 30 be charged more sufficiently, and the voltage value of the charged data line 30 is closer to the target voltage of the first data signal, thereby reducing the voltage required by the first sub-pixel 41 for switching to the dark state. When the first sub-pixel 41 has the greatest emission among the three colors of sub-pixels, the dark-state voltage of the display panel depends on the dark-state voltage of the first sub-pixel 41, so the driving method provided by embodiments of the present disclosure can reduce the dark-state voltage of the display panel. As shown in FIG. 1, the display panel further includes power supply lines 50 each extending in a same direction as the data line 30, and each power supply line 50 is connected to multiple sub-pixels 40. There exists a large coupling effect between the data line 30 and the power supply line 50. It should be noted that, in order to distinguish between the data line 30 and the power supply line 50, in FIG. 1, the power supply line 50 is represented by the thick black line, and the data line 30 is represented by the thin black line. The present disclosure is not limited by the thick-thin relationship of the lines in FIG. 1. For the display panel with a reduced dark-state voltage, when the data line 30 drives the sub-pixel 40 to switch to the black greyscale, the changing amplitude of the voltage on the data line 30 is reduced, and the fluctuation of the voltage on the power supply line 50 caused by the coupling with the data line 30 is reduced. After the switch 11 connected to the data line 30 is turned off, the data line 30 is in a floating state. Accordingly, the fluctuation of the voltage on the power supply line 50 has a reduced influence on the voltage on the data line 30. As a result, the line-to-line cross talk between the data line 30 and the power supply line 50 is reduced, and the display effect is improved. The driving method provided by embodiments of the present disclosure can reduce the line-to-line cross talk between the data line 30 and other signal lines (such as the power supply line, the scan line, and the like), improving the display effect.

In another aspect, the driving method provided by embodiments of the present disclosure can reduce the dark-state voltage of the display panel, and thus reduce the power supply voltage provided by the display driving chip to the display panel, thereby reducing the power consumption of the display driving chip. In yet another aspect, if the driving transistor in the pixel circuit operates in the biased state for a long time, the threshold voltage of the driving transistor is drifted, and the threshold voltage drifting may cause a blur problem in the initial frame after frame switching or image switching. Since the dark-state voltage affects the drift amount of the threshold voltage, the display brightness of the initial frame can be improved by reducing the dark-state voltage, thereby reducing the display blur problem. In yet another aspect, since the charging time duration for inputting the first data signal to the data line 30 is the longest, the first data signal is inputted more sufficiently, and the display greyscale of the first sub-pixel 41 is more accurate. If the first sub-pixel 41 has the greatest luminance proportion when the first sub-pixel 41, the second sub-pixel 42 and the third sub-pixel 43 cooperate to emit a white light, for example, the first sub-pixel 41 is a green sub-pixel, the visual effect of the low-greyscale display can be improved.

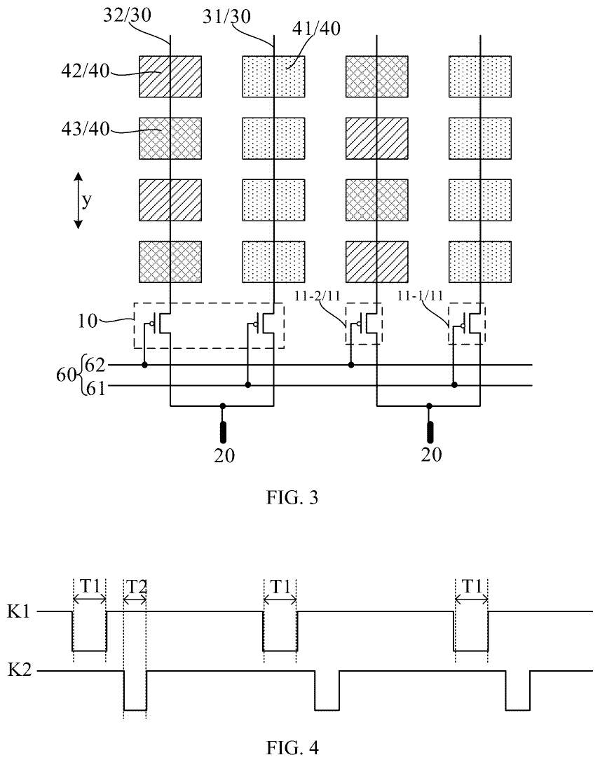

In some embodiments, as shown in FIG. 1, the data lines 30 include first data lines 31 and second data lines 32. The first data line 31 is connected to the first sub-pixel 41, and the second data line 32 is connected to the second sub-pixel 42 or the third sub-pixel 43. FIG. 3 is a schematic diagram of another display panel according to one or more embodiments of the present disclosure. In some example embodiments, n=2, as shown in FIG. 3, the first data line 31 is connected to the first sub-pixel 41, and the second data line 32 is connected to the second sub-pixel 42 and the third sub-pixel 43. In the embodiments shown in FIG. 1 and the embodiments shown in FIG. 3, the first date line 31 is only connected to the first sub-pixel 41. In other words, the first data line 31 only drives the first sub-pixel 41.

Embodiments of the present disclosure provide another driving method, which can be used to drive the display panel shown in FIG. 1 and FIG. 3. The arrangement that the turned-on time duration of the switch 11 corresponding to the time period in which the first data signal is supplied to the input terminal of the demultiplexer 10 is the longest includes the following features: the turned-on time duration of the switch 11 connected to the first data line 31 is longer than the turned-on time duration of the switch 11 connected to the second data line 32. In this embodiment, the first data line 31 is connected to the first sub-pixel 41, and the first sub-pixel 41 does not share the data line with a different color of sub-pixel. With this arrangement, the turned-on time duration of the switch 11 connected to the first data line 31 can be controlled conveniently. FIG. 4 is a timing diagram of a control signal of a switch according to one or more embodiments of the present disclosure. The first control signal K1 in embodiments shown in FIG. 4 can drive the switch 11 connected to the first data line 31 in embodiments shown in FIG. 1 and FIG. 3, and the second control signal K2 in embodiments shown in FIG. 4 can drive the switch 11 connected to the second data line 32 in embodiments shown in FIG. 1 and FIG. 3. The following description is made with an example in which the switch 11 is turned on by a low level. As shown in FIG. 4, the time duration of one low level in the first control signal K1 is T1, so the time duration of one turning on of the switch 11 connected to the first data line 31 is T1. That means the turned-on time duration t₀₁ of the switch 11 corresponding to the time period in which the data terminal 20 inputs the first data signal to the data line 30 is equal to T1. The time duration of one low level in the second control signal K2 is T2, so the time duration of one turning on of the switch 11 connected to the second data line 32 is T2.

In the embodiments shown in FIG. 1 and FIG. 3, the first data line 31 is only connected to the first sub-pixel 41, so the signal each time inputted to the first data line 31 is the first data signal, and the turned-on time duration of each turning on of the switch 11 connected to the first data line 31 can be T1. This simplifies the timing setup of the first control signal K1 of the switch 11 corresponding to the first data line 31. The first control signal K1 is a time periodic pulse signal, and the time duration of an active level signal in each signal cycle is equal, so the implementation of the first control signal K1 is easier. In addition, it is arranged that the turned-on time duration of the switch 11 connected to the first data line 31 is longer than the turned-on time duration of the switch 11 connected to the second data line 32. This arrangement ensures that the turned-on time duration of the switch 11 corresponding to the time period in which the first data signal is inputted to the input terminal of the demultiplexer 10 is the longest. As a result, the voltage required by the first sub-pixel 41 for switching to the dark state is reduced. The dark-state voltage of the display panel depends on the dark-state voltage of the first sub-pixel 41. With the driving method provided by embodiments of the present disclosure, the dark-state voltage of the display panel is reduced, and thus the line-to-line crosstalk between the data line 30 and the power supply line when the sub-pixel 40 is switched to the black greyscale can be reduced, thereby improving the display effect.

In some embodiments, as shown in FIG. 1 or FIG. 3, the switches 11 include first switches 11-1, and each first switch 11-1 is connected to the first data line 31. The display panel further includes control lines 60. A control terminal of the switch 11 is connected to the control line 60. The control lines 60 include first control lines 61. The control terminals of the first switches 11-1 are connected to a same first control line 61.

In an example, in the embodiment shown in FIG. 1, when n=4, the output terminals of the demultiplexer 10 are connected to two first data lines 31 and two second data lines 32 respectively. Then, one demultiplexer 10 is provided with two first switches 11-1, and the two first switches 11-1 are connected to two corresponding first data lines 31 respectively. The display panel includes two first control lines 61, and the two first control lines 61 control the two first switches 11-1 in the demultiplexer 10 respectively. Each demultiplexer 10 includes one first switch 11-1 electrically connected to one of the two first control lines 61, and the other one first switch 11-1 electrically connected to the other one of the two first control lines 61. That is, one first control line 61 is connected to first switches 11-1 of multiple different demultiplexers 10. In an example, as shown in FIG. 3, n=2, the output terminals of each demultiplexer 10 are connected to one first data line 31 and one second data line 32 respectively, and each demultiplexer 10 includes one first switch 11-1. Then, the display panel includes one first control line 61, and the one first control line 61 controls the first switches 11-1 of multiple demultiplexers 10.

Embodiments of the present disclosure further provide another driving method that can be used to drive the display panel in embodiments shown in FIG. 1 and FIG. 3. The driving method includes a step S201. In step S201, the first control line 61 provides an enable signal that simultaneously turns on the multiple first switches 11-1 connected to the first control line 61. That is, the enable signal of the first control line 61 controls the charging time duration of all of the multiple first switches 11-1. In some embodiments, the first control line 61 provides the first control signal K1 as shown in FIG. 4. The first control line 61 in the display panel can simultaneously control the operation of multiple first switches 11-1. With the driving method provided by embodiments of the present disclosure, it does not need to change the connection manner of the first switches 11-1 in multiple demultiplexers 10 and the control lines 60, and the charging time duration of the first data line 31 can be increased by just adjusting the time duration (also referred to as time duration) during which the first control line 61 provides the active level once, such that the voltage value of the charged first data line 31 is closer to the target voltage of the first data signal, thereby reducing the voltage required by the first sub-pixel 41 for switching to the dark state. Since the dark-state voltage of the display panel depends on the dark-state voltage of the first sub-pixel 41, the driving method provided by embodiments of the present disclosure can reduce the dark-state voltage of the display panel and reduce the line-to-line crosstalk between the data line 30 and the power supply line when the greyscale of the sub-pixel 40 is switched to the dark-state greyscale, thereby improving the display effect.

In some embodiments, as shown in FIG. 1 or FIG. 3, the switches 11 include a second switch 11-2. The second switch 11-2 is connected to the second data line 32. The control lines 60 include a second control line 62. The control terminals of multiple second switches 11-2 are connected to a same second control line 62. In the embodiment shown in

FIG. 1, the output terminals of the demultiplexer 10 are connected to two second data lines 32, and each demultiplexer 10 includes two second switches 11-2 that are connected to two second data lines 32 respectively. The display panel includes two second control lines 62, and the two second switches 11-2 in the demultiplexer 10 are respectively controlled by the two second control lines 62. In the embodiment shown in FIG. 3, the output terminal of the demultiplexer 10 is connected to one second data line 32, and each demultiplexer 10 includes one second switch 11-2. The display panel includes one second control line 62 that controls the second switches 11-2 in multiple demultiplexers 10.

As shown in FIG. 4, the first control line 61 provides the first control signal K1, and the second control line 62 provides the second control signal K2. In some embodiments, the second switch 11-2 is controlled by the second control line 62, and the second data line 32 connected to the second switch 11-2 is coupled to sub-pixels 40 other than the first sub-pixel 41. In step S201, the first control line 61 provides an enable signal that simultaneously turns on multiple first switches 11-1 connected to the first control line 61, the second control line 62 provides an enable signal that simultaneously turns on the multiple second switches 11-2 connected to the second control line 62, the time duration of the active level of the enable signal provided by the first control line 61 is longer than the time duration of the active level of the enable signal provided by the second control line 62. With the driving method provided by embodiments of the present disclosure, it does not need to change the correspondence and connection manner of the switches 11 in multiple demultiplexers 10 and the control lines 60 and does not need to change the enable signal provided by the second control line 62, and it just needs to increase the time duration of the active level of the enable signal provided by the first control line 61 to increase the turned-on time duration of the first switch 11-1. In this way, the voltage value of the charged first data line 31 is closer to the target voltage of the first data signal, and the dark-state voltage of the first sub-pixel 41 is reduced. Since the dark-state voltage of the display panel depends on the dark-state voltage of the first sub-pixel 41, the driving method provided by embodiments of the present disclosure can reduce the dark-state voltage of the display panel and reduce the line-to-line crosstalk between the data line 30 and the power supply line when the greyscale of the sub-pixel 40 is switched to the dark-state greyscale, thereby improving the display effect.

In embodiments of the present disclosure, the sub-pixel 40 includes a pixel circuit. The pixel circuit may be implemented in any one of various circuit structures. For example, the pixel circuit may include seven transistors and one storage capacitor. Each pixel circuit drives one light-emitting element. Multiple pixel circuits are arranged in an array, thereby ensuring uniformity of the etching process in the formation of the pixel circuits and ensuring that a same kind of the functional transistors in the pixel circuits are basically the same in characteristics.

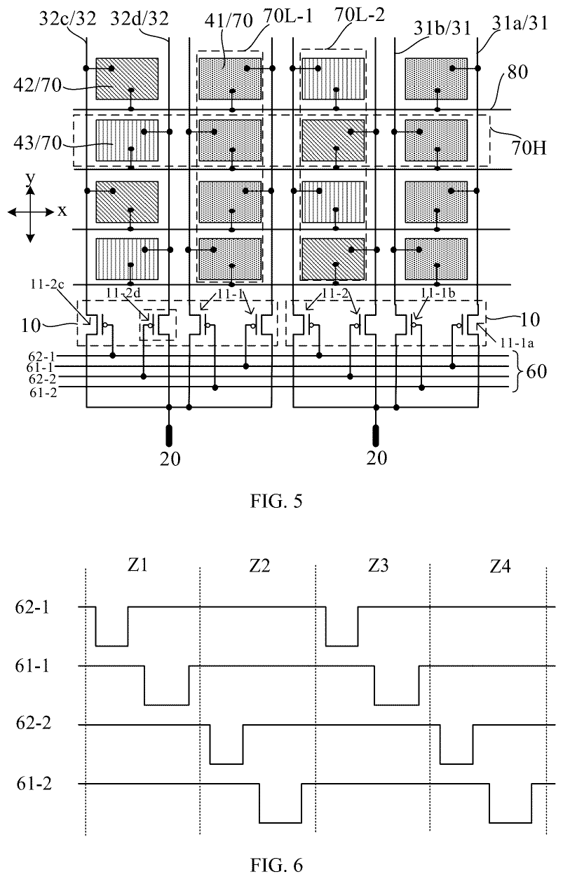

FIG. 5 is a schematic diagram of yet another display panel according to one or more embodiments of the present disclosure. FIG. 5 can be understood with reference to FIG. 1. FIG. 5 shows the arrangement of pixel circuits 70 in the display panel. Multiple pixel circuits 70 are arranged in a second direction x to define a pixel circuit row 70H, where the second direction x crosses the first direction y. In FIG. 5, the pixel circuits in different colors of sub-pixels are represented by different fill patterns. The display panel further includes scan lines 80, and each scan line 80 drives one pixel circuit row 70H. When the display panel is driven to work, multiple scan lines 80 sequentially provide the enable signal to multiple pixel circuit rows 70H to drive the multiple pixel circuit rows 70H row by row. The scan lines 80 and the data lines 30 cooperate to input the data signals to the pixel circuits 70, and thus the pixel circuits 70 drive the light-emitting elements to emit light.

The driving method provided by embodiments of the present disclosure includes: supplying, by multiple data terminals 20, data signals to the input terminals of multiple demultiplexers 10 so as to input a row data signal to the multiple data lines 30. The row data signal includes the data signals required by the pixel circuits 70 in this pixel circuit row 70H. The display panel includes multiple pixel circuit rows 70H. When the display panel displays a frame of image, each pixel circuit row 70H requires a set of row data signal. The row data signal includes multiple data signals, and the number of the multiple data signals is equal to the number of the pixel circuits in the pixel circuit row 70H. When the display panel is driven to display, the input process of the row data signal and the time when the scan line 80 provides the enable signal cooperate so as to drive one pixel circuit row 70H. In the time period during which the row data signal is inputted to multiple data lines 30, in one demultiplexer 10, the switch 11 connected to the first data line 31 and the switch 11 connected to the second data line 32 each are turned on once. When the switch 11 connected to the first data line 31 is turned on, the first data signal is inputted to the first data line 31. When the switch 11 connected to the second data line 32 is turned on, the second data signal or the third data signal is inputted to the second data line 32. According to the driving method provided by embodiments of the present disclosure, during the inputting of the row data signal, two switches 11 in each demultiplexer 10 are turned on in different time periods respectively. That is, the two switches 11 are turned on in a time division manner, and the turned-on time periods of the two switches 11 do not overlap each other. In addition, the turned-on time duration of the switch 11 connected to the first data line 31 is longer than the turned-on time duration of the switch 11 connected to the second data line 32. The time duration of inputting the row data signal is substantially equal to a sum of the turned-on time duration of the switch 11 connected to the first data line 31 and the turned-on time duration of the switch 11 connected to the second data line 32. Each pixel circuit row 70H is connected to sub-pixels of different colors. Therefore, in the input process of the row data signal, the data voltages corresponding to the sub-pixels of different colors are inputted to the pixel circuit row 70H.

The demultiplexer 10 is provided, thus in the input process of the row data signal, each demultiplexer 10 controls data inputting of at least two pixel circuits 70 in the pixel circuit row 70H. Since the input terminal of each demultiplexer 10 is connected to only one data terminal 20, the inputting of the data voltages of the entire pixel circuit row 70H is carried out by sequentially turning on the switches in the demultiplexer 10. In embodiments of the present disclosure, in the input process of the row data signal, the two switches 11 in the demultiplexer 10 are turned on separately in different time periods, so the time duration of inputting the row data signal is determined by the sum of the turned-on time durations of the two switches 11. Even if the turned-on time duration of the switch 11 connected to the first data line 31 is increased for reducing the line-to-line crosstalk caused when the sub-pixel 40 is switched to a black greyscale, the time duration of inputting the row data signal is not too long. The time duration of inputting the row data signal cooperates with the scan line 80 to meet the frame refresh time of the display panel.

In some embodiments, the output terminals of the demultiplexer 10 are connected to at least one first data line 31 and at least one second data line 32. The switches 11 include the first switch 11-1 electrically connected to the first data line 31 and the second switch 11-2 electrically connected to the second data line 32. In the example embodiment shown in FIG. 1, the output terminals of the demultiplexer 10 are connected to two first data lines 31 and two second data lines 32. In the example embodiment shown in FIG. 3, the output terminals of the demultiplexer 10 are connected to one first data line 31 and one second data line 32. In the driving method provided by embodiments of the present disclosure, the configuration that the turned-on time duration of the switch 11 corresponding to the time period in which the first data signal is supplied to the input terminal of the demultiplexer 10 is the longest in step S101 includes: sequentially supplying, by the data terminal 20, data signals to the input terminal of the demultiplexer 10, and turning on the first switch 11-1 and the second switch 11-2 in the demultiplexer 10 in different time periods. That is, the first switch 11-1 and the second switch 11-2 are turned on in a time division manner, and the turned-on time period of the first switch 11-1 and the turned-on time period of the second switch 11-2 have no overlapping. The turned-on time duration of the first switch 11-1 is longer than the turned-on time duration of the second switch 11-2. Since the first switch 11-1 and the second switch 11-2 in the demultiplexer 10 are turned on in different time periods, one data terminal 20 can provide data signals required by sub-pixels of different colors in different time periods, achieving multiplexing of the data terminal 20. The data terminal 20, the demultiplexer 10, and the data line 30 cooperate so as to reduce the number of the data terminals 20 in the display panel. As a result, the number of pins in the display driving chip is reduced, and the cost is reduced. In addition, the voltage required by the first sub-pixel 41 for switching to the dark state is reduced by increasing the turned-on time duration of the first switch 11-1, and thus the dark-state voltage of the display panel is reduced, thereby reducing the line-to-line crosstalk when the sub-pixel 40 is switched to the black greyscale.

In some embodiments, as shown in FIG. 5, multiple pixel circuits 70 in multiple first sub-pixels 41 are arranged in the first direction y to define a first pixel circuit column 70L-1, and the pixel circuits 70 in the second sub-pixels 42 and the pixel circuits 70 in the third sub-pixels 43 are alternately arranged in the first direction y to define a second pixel circuit column 70L-2. The first data lines 31 include a first data sub-line 31a and a second data sub-line 31b. The first data sub-line 31a is electrically connected to odd-numbered pixel circuits 70 in the first pixel circuit column 70L-1, and the second data sub-line 31b is electrically connected to even-numbered pixel circuits 70 in the first pixel circuit column 70L-1. The first switches 11-1 include a first sub-switch 11-1a electrically connected to the first data sub-line 31a, and a second sub-switch 11-1b electrically connected to the second data sub-line 31b. The second data lines 32 include a third data sub-line 32c and a fourth data sub-line 32d. The third data sub-line 32c is electrically connected to the odd-numbered pixel circuits 70 in the second pixel circuit column 70L-2, and the fourth data sub-line 32d is electrically connected to the even-numbered pixel circuits 70 in the second pixel circuit column 70L-2. The second switches 11-2 include a third sub-switch 11-2c electrically connected to the third data sub-line 32c and a fourth sub-switch 11-2d electrically connected to the fourth data sub-line 32d. The demultiplexer 10 includes the first sub-switch 11-1a, the second sub-switch 11-1b, the third sub-switch 11-2c, and the fourth sub-switch 11-2d.

Embodiments of the present disclosure provide a driving method that can be used for driving the display panel in the embodiment shown in FIG. 5. As shown in FIG. 5, the control lines 60 include two first control lines and two second control lines. The two first control lines are a first control sub-line 61-1 and a second control sub-line 61-2 respectively. The two second control lines 62 are a third control sub-line 62-1 and a fourth control sub-line 62-2. A control terminal of the first sub-switch 11-1a is connected to the first control sub-line 61-1, a control terminal of the second sub-switch 11-1b is connected to the second control sub-line 61-2, a control terminal of the third sub-switch 11-2c is connected to the third control sub-line 62-1, and a control terminal of the fourth sub-switch 11-2d is connected to the fourth control sub-line 62-2.

FIG. 6 is an operation timing diagram of the demultiplexer in the embodiment of FIG. 5. FIG. 6 shows the timing when the demultiplexer in FIG. 5 successively drives four pixel circuit rows 70H. With reference to FIG. 5 and FIG. 6, turning on the first switch 11-1 and the second switch 11-2 in the demultiplexer 10 in different time periods in the driving method includes: alternately turning on the first switch 11-1 and the second switch 11-2 in the demultiplexer 10.

During the time period of inputting data signals to the odd-numbered pixel circuits 70 in the first pixel circuit column 70L-1 and the odd-numbered pixel circuits 70 in the second pixel circuit column 70L-2, the first sub-switch 11-1a and the third sub-switch 11-2c are turned on in different time periods, and the turned-on time duration of the first sub-switch 11-1a is longer than the turned-on time duration of the third sub-switch 11-2c. The turned-on order of the first sub-switch 11-1a and the third sub-switch 11-2c is not limited. During the time period of inputting data signals to the even-numbered pixel circuits 70 in the first pixel circuit column 70L-1 and the even-numbered pixel circuits 70 in the second pixel circuit column 70L-2, the second sub-switch 11-1b and the fourth sub-switch 11-2d are turned on in different time periods, and the turned-on time duration of the second sub-switch 11-1b is longer than the turned-on time duration of the fourth sub-switch 11-2d. The turned-on order of the second sub-switch 11-1b and the fourth sub-switch 11-2d is not limited.

In FIG. 6, the time period Z1 corresponds to the row data signal input time period of the first pixel circuit row 70H in FIG. 5, and the time periods Z2, Z3, and Z4 can be understood by reference. In FIG. 5, the first pixel circuit row 70H is one of odd-numbered pixel circuit rows 70H, and the odd-numbered pixel circuits in the first pixel circuit column 70L-1 and the second pixel circuit column 70L-2 are located in the odd-numbered pixel circuit rows 70H. The time period Z2 is the time period of driving the second pixel circuit row 70H in FIG. 5. The second pixel circuit row 70H is one of the even-numbered pixel circuit rows 70H. The even-numbered pixel circuits in the first pixel circuit column 70L-1 and the second pixel circuit column 70L-2 are located in the even-numbered pixel circuit rows 70H.

In the time period Z1, the first-one second control line 62-1 supplies a low-level enable signal that turns on the third sub-switch 11-2c, and the data terminal 20 is connected to the third data sub-line 32c through the turned-on third sub-switch 11-2c and supplies a data voltage to the third data sub-line 32c. In FIG. 5, the left data terminal 20 inputs a second data signal (corresponding to the second sub-pixel 42) to the third data sub-line 32c, and the right data terminal 20 inputs a third data signal (corresponding to the third sub-pixel 43) to the third data sub-line 32c. The first-one first control line 61-1 supplies a low-level enable signal that turns on the first sub-switch 11-1a, and the data terminal 20 is connected to the first data sub-line 31a through the turned-on first sub-switch 11-1a and supplies a first data signal (corresponding to the first sub-pixel 41) to the first data sub-line 31a. The time duration of the low-level enable signal provided by the first-one first control line 61-1 is longer than the time duration of the low-level enable signal provided by the first-one second control line 62-1. As a result, the turned-on time duration of the first sub-switch 11-1a is longer than the turned-on time duration of the third sub-switch 11-2c.

In the time period Z2, the second-one second control line 62-2 supplies a low-level enable signal that turns on the fourth sub-switch 11-2d, and the data terminal 20 is connected to the fourth data sub-line 32d through the turned-on fourth sub-switch 11-2d and supplies a data voltage to the fourth data sub-line 32d. In FIG. 5, the left data terminal 20 inputs a third data signal to the fourth sub-line 32d, and the right data terminal 20 inputs a second data signal to the fourth sub-line 32d. The second-one first control line 61-2 supplies a low-level enable signal that turns on the second sub-switch 11-1b, and the data terminal 20 is connected to the second data sub-line 31b though the turned-on second sub-switch 11-1b and supplies the first data signal to the second data sub-line 31b. The time duration of the low-level enable signal provided by the second-one first control line 61-2 is longer than the time duration of the low-level enable signal provided by the second-one second control line 62-2. As a result, the turned-on time duration of the second sub-switch 11-1b is longer than the turned-on time duration of the fourth sub-switch 11-2d.

In the driving method provided by embodiments of the present disclosure, the first switch 11-1 and the second switch 11-2 in the demultiplexer 10 are turned on alternately, the first sub-switch 11-1a and the third sub-switch 11-2c are turned on in different time periods in the time period of inputting the row data signal to the odd-numbered pixel circuit row, and the second sub-switch 11-1b and the fourth sub-switch 11-2d are turned on in different time periods in the time period of inputting the row data signal to the even-numbered pixel circuit row. The data signal of the odd-numbered pixel circuit in the first pixel circuit column 70L-1 is inputted though the first sub-switch 11-1a. The data signal of the even-numbered pixel circuit in the first pixel circuit column 70L-1 is inputted though the second sub-switch 11-1b. In this way, the first data sub-line 31a and the second data sub-line 31b alternately drive the first pixel circuit column 70L-1. Similarly, the third data sub-line 32c and the fourth data sub-line 32d alternately drive the second pixel circuit column 70L-2. In this way, the charging time duration of each data line is sufficient, thereby avoiding image distortion caused by insufficient charging of the data line. Based on the above, the turned-on time duration of the first sub-switch 11-1a and the turned-on time duration of the second sub-switch 11-1b are both increased, so the charging time duration for inputting the first data signal to the first data line 31 is increased, and thus the voltage required by the first sub-pixel 41 for switching to the dark state is reduced. The dark-state voltage of the display panel depends on the dark-state voltage of the first sub-pixel 41. With the driving method provided by embodiments of the present disclosure, the dark-state voltage of the display panel can be reduced, and thus the line-to-line crosstalk between the data line 30 and the power supply line when the sub-pixel 40 is switched to the black greyscale is reduced, thereby improving the display effect. In addition, in some embodiments, the time duration of inputting the row data signal is basically equal to the sum of the turned-on time duration of the first switch 11-1 and the turned-on time duration of the second switch 11-2. The time duration of inputting the row data signal is determined only by the sum of the turned-on time durations of the two switches 11 that are turned on in the time division manner. Increasing the turned-on time duration of the first switch 11-1 has little affecting on the time duration of inputting the row data signal. The time duration of inputting the row data signal cooperates with the scan line 80 to meet the frame refresh time of the display panel.

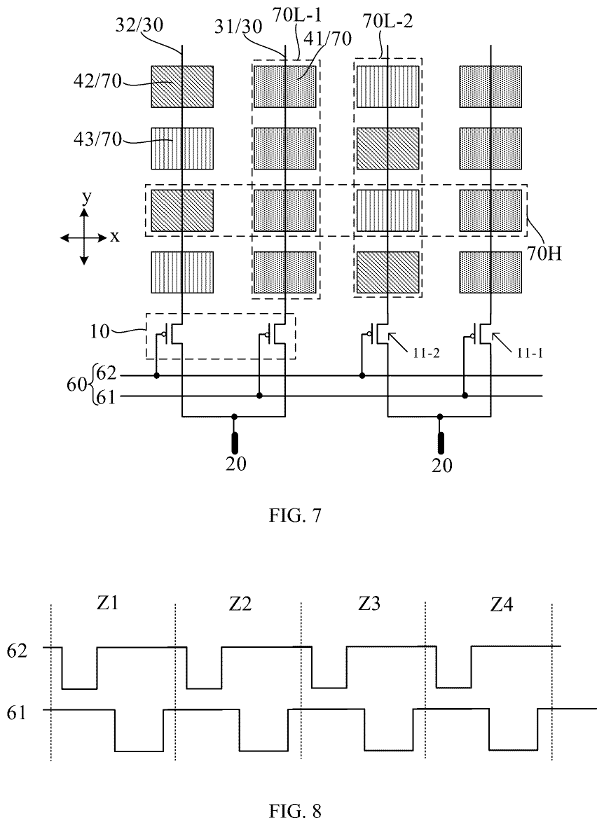

FIG. 7 is a schematic diagram of yet another display panel according to one or more embodiments of the present disclosure. In some embodiments, as shown in FIG. 7, the pixel circuits 70 are arranged in an array, multiple pixel circuits 70 are arranged along the second direction x to define a pixel circuit row 70H, multiple pixel circuits 70 of multiple first sub-pixels 41 are arranged along the first direction y to define a first pixel circuit column 70L-1, and pixel circuits 70 in the second sub-pixels 42 and pixel circuits 70 in the third sub-pixels 43 are alternately arranged along the first direction y to define a second pixel circuit column 70L-2. The first data line 31 is electrically connected to the pixel circuits 70 in the first pixel circuit column 70L-1. The second data line 32 is connected to the pixel circuits 70 in the second pixel circuit column 70L-2. The output terminals of the demultiplexer 10 are connected to one first data line 31 and one second data line 32. The demultiplexer 10 includes one first switch 11-1 and one second switch 11-2. The first switch 11-1 is connected to the first data line 31, and the second switch 11-2 is connected to the second data line 32. A control terminal of the first switch 11-1 is connected to the first control line 61, and a control terminal of the second switch 11-2 is connected to the second control line 62.

Embodiments of the present disclosure provide a driving method for driving the display panel in the embodiment of FIG. 7. FIG. 8 is an operation timing diagram of the demultiplexer in FIG. 7. FIG. 8 shows the timing when the demultiplexer in FIG. 7 successively drives four pixel circuit rows 70H. With reference to FIG. 7 and FIG. 8, in the driving method, the step of supplying, by the data terminal 20, data signals sequentially to the input terminal of the demultiplexer 10 and turning on the first switch 11-1 and the second switch 11-2 in the demultiplexer 10 in different time periods is as follows. When the data terminal 20 supplies the first data signal to the input terminal of the demultiplexer 10, the first switch 11-1 is turned on so as to input the first data signal to the first data line 31. When the data terminal 20 supplies the second data signal to the input terminal of the demultiplexer 10, the second switch 11-2 is turned on so as to input the second data signal to the second data line 32. When the data terminal 20 supplies the third data signal to the input terminal of the demultiplexer 10, the second switch 11-2 is turned on so as to input the third data signal to the second data line 32. The second data signal corresponds to the second sub-pixel 42, and the third data signal corresponds to the third sub-pixel 43. In this embodiment, the second sub-pixel 42 and the third sub-pixel 43 are both connected to the second data line 32, and the second data signal and the third data signal both need to be inputted tot the second data line 32, so the second data signal and the third data signal can be considered to be the same type data signal.

In FIG. 8, the time period Z1 corresponds to the row data signal input time period of the first pixel circuit row 70H in FIG. 7, and the time periods Z2, Z3, and Z4 can be understood by reference.

In the time period Z1, the second control line 62 supplies a low-level enable signal that turns on the second switch 11-2, and the data terminal 20 is connected to the second data line 32 through the turned-on second switch 11-2 and supplies a data voltage to the second data line 32. In FIG. 7, the left data terminal 20 inputs the second data signal to the second data line 32, and the right data terminal 20 inputs the third data signal to the second data line 32. The first control line 61 supplies a low-level enable signal that turns on the first switch 11-1, and the data terminal 20 is connected to the first data line 31 through the turned-on first switch 11-1 and supplies a first data signal to the first data line 31. The time duration of the low-level enable signal provided by the first control line 61 is longer than the time duration of the low-level enable signal provided by the second control line 62. As a result, the turned-on time duration of the first switch 11-1 is longer than the turned-on time duration of the second switch 11-2.

In the time period Z2, the second control line 62 supplies a low-level enable signal that turns on the second switch 11-2, and the data terminal 20 is connected to the second data line 32 through the turned-on second switch 11-2. The left data terminal 20 in FIG. 7 inputs the third data signal to the left second data line 32, and the right data terminal 20 in FIG. 7 inputs the second data signal to the right second data line 32. The first control line 61 supplies the low-level enable signal that turns on the first switch 11-1, and the data terminal 20 is connected to the first data line 31 and supplies the first data signal to the first data line 31. The time duration of the low-level enable signal provided by the first control line 61 is longer than the time duration of the low-level enable signal provided by the second control line 62. As a result, the turned-on time duration of the first switch 11-1 is longer than the turned-on time duration of the second switch 11-2.

In the driving method provided by embodiments of the present disclosure, during the driving process of one pixel circuit row 70, the first switch 11-1 and the second switch 11-2 in the demultiplexer 10 are turned on alternately, and the turned-on time duration of the first switch 11-1 is longer, such that the charging time duration for inputting the first data signal to the first data line 31 is longer. As a result, the voltage required by the first sub-pixel 41 for switching to the dark state is reduced. The dark-state voltage of the display panel depends on the dark-state voltage of the first sub-pixel 41. With the driving method provided by embodiments of the present disclosure, the dark-state voltage of the display panel can be reduced, and thus the line-to-line crosstalk between the data line 30 and the power supply line when the sub-pixel 40 is switched to the black greyscale is reduced, thereby improving the display effect. In addition, in embodiments of the present disclosure, the time duration of inputting the row data signal is basically equal to the sum of the turned-on time duration of the first switch 11-1 and the turned-on time duration of the second switch 11-2. The time duration of inputting the row data signal is determined only by the sum of the turned-on time durations of the two switches 11 that are turned on in the time division manner. Increasing the turned-on time duration of the first switch 11-1 has little affecting on the time duration of inputting the row data signal. The time duration of inputting the row data signal cooperates with the scan line 80 to meet the frame refresh time of the display panel.

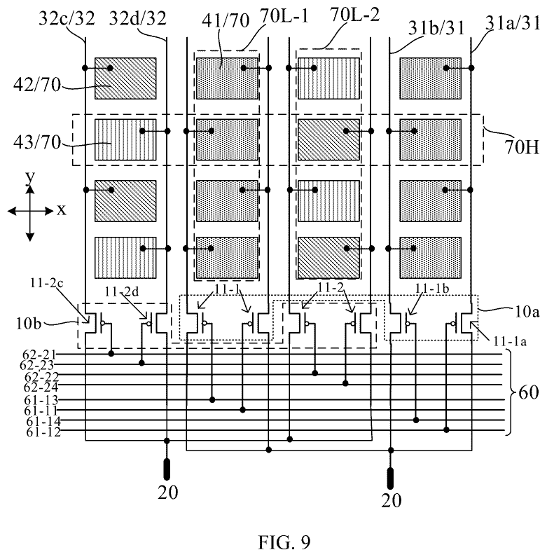

FIG. 9 is a schematic diagram of yet another display panel according to one or more embodiments of the present disclosure. In some embodiments, as shown in FIG. 9, for example, n=4. The demultiplexers 10 include a first demultiplexer 10a and a second demultiplexer 10b. The switches 11 include first switches 11-1 connected to first data lines 31 and second switches 11-2 connected to second data lines 32. The first demultiplexer 10a includes first switches 11-1. The second demultiplexer 10b includes second switches 11-2. The output terminals of the first demultiplexer 10a are connected to at least two first data lines 31. The output terminals of the second demultiplexer 10b are connected to at least two second data lines 32. The first data line 31 is connected to multiple first sub-pixels 41. The second data line 32 is connected to multiple second sub-pixels 42, or the second data line 32 is connected to multiple third sub-pixels 43.

The configuration that in step S101, the turned-on time duration of the corresponding switch 11 when the first data signal is supplied to the input terminal of the demultiplexer 10 is the longest is as follows. The data terminal 20 supplies data signals to the input terminal of the first demultiplexer 10a, and the first switches 11-1 in the first demultiplexer 10a are turned on in different time periods. The data terminal supplies data signals to the input terminal of the second demultiplexer 10b, and the second switches 11-2 in the second demultiplexer 10b are turned on in different time periods. The turned-on time duration of the first switch 11-1 is longer than the turned-on time duration of the second switch 11-2. In this embodiment, the data terminal 20 is connected to the first data line 31 through the turned-on first switch 11-1, and the first data signal is inputted to the first data line 31. The charging of the first data line 31 is more sufficient by increasing the turned-on time duration of the first switch 11-1 in the first demultiplexer 10a, and the voltage value of the charged first date line 31 is closer to the target voltage of the first data signal. As a result, the voltage required by the first sub-pixel 41 for switching to the dark state is reduced. The dark-state voltage of the display panel depends on the dark-state voltage of the first sub-pixel 41, so the dark-state voltage of the display panel can be reduced. In this case, the line-to-line crosstalk between the data line 30 and other signal line when the sub-pixel 40 is switched to the black greyscale is reduced, thereby improving the display effect.

In some embodiments, as shown in FIG. 9, multiple pixel circuits 70 are arranged in an array, multiple pixel circuits 70 of multiple first sub-pixels 41 are arranged along the first direction y to define a first pixel circuit column 70L-1, pixel circuits 70 in the second sub-pixels 42 and pixel circuits 70 in the third sub-pixels 43 are alternately arranged along the first direction y to define a second pixel circuit column 70L-2, and multiple pixel circuits 70 are arranged along the second direction x to define a pixel circuit row 70H. The second direction x crosses the first direction y.

The first data lines 31 include a first data sub-line 31a and a second data sub-line 31b. The first data sub-line 31a is electrically connected to odd-numbered pixel circuits 70 in the first pixel circuit column 70L-1. The second data sub-line 31b is electrically connected to even-numbered pixel circuits 70 in the first pixel circuit column 70L-1. The first switches 11-1 include a first sub-switch 11-1a electrically connected to the first data sub-line 31a, and a second sub-switch 11-1b electrically connected to the second data sub-line 31b.

The second data lines 32 include a third data sub-line 32c and a fourth data sub-line 32d. The third data sub-line 32c is electrically connected to the odd-numbered pixel circuits 70 in the second pixel circuit column 70L-2, and the fourth data sub-line 32d is electrically connected to the even-numbered pixel circuits 70 in the second pixel circuit column 70L-2. The second switches 11-2 include a third sub-switch 11-2c electrically connected to the third data sub-line 32c, and a fourth sub-switch 11-2d electrically connected to the fourth data sub-line 32d.

The first demultiplexer 10a includes two first sub-switches 11-1a and two second sub-switches 11-1b. The second demultiplexer 10b includes two third sub-switches 11-2c and two fourth sub-switches 11-2d. The display panel includes four first control lines and four second control lines. Two first sub-switches 11-1a and two second sub-switches 11-1b are electrically connected to the four first control lines respectively. Four first control lines include a first-type first control sub-line 61-11, a first-type second control sub-line 61-12, a first-type third control sub-line 61-13, and a first-type fourth control sub-line 61-14, respectively. Two third sub-switches 11-2c and two fourth sub-switches 11-2d are electrically connected to four second control lines, respectively. Four second control lines include a second-type first control sub-line 62-21, a second-type second control sub-line 62-22, a second-type third control sub-line 62-23, and a second-type fourth control sub-line 62-24, respectively.

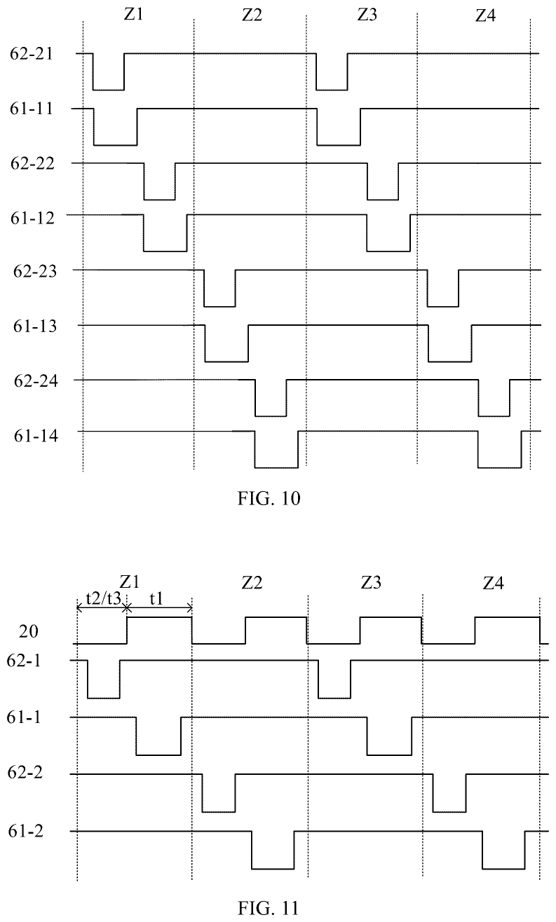

FIG. 10 is an operation timing diagram of the demultiplexer in FIG. 9. FIG. 10 shows the timing of the input time period of the row data signal when the demultiplexer in FIG. 9 successively drives four pixel circuit rows 70H. With reference to FIG. 9 and FIG. 10, in the driving method, the turning on the first switches 11-1 in the first demultiplexer 10a in different time periods is as follows. During the time period of inputting data signals to the odd-numbered pixel circuits 70 in the first pixel circuit column 70L-1, two first sub-switches 11-1a are turned on in different time periods. During the time period of inputting data signals to the even-numbered pixel circuits 70 in the first pixel circuit column 70L-1, two second sub-switches 11-1b are turned on in different time periods. The turning on the second switches 11-2 in the second demultiplexer 10b in different time periods is as follows. During the time period of inputting data signals to the odd-numbered pixel circuits 70 in the second pixel circuit column 70L-2, two third sub-switches 11-2c are turned on in different time periods. During the time period of inputting data signals to the even-numbered pixel circuits 70 in the second pixel circuit column 70L-2, two fourth sub-switches 11-2d are turned on in different time periods.

As shown in FIG. 10, the time period Z1 corresponds to the timing of the input time period of the row data signal of the first pixel circuit row 70H from top to down in FIG. 9. The first pixel circuit row 70H is one of odd-numbered pixel circuit rows.

In the time period Z1, the second-type first control sub-line 62-21 supplies a low-level enable signal that turns on one third sub-switch 11-2c in the second demultiplexer 10b. The left data terminal 20 in FIG. 9 is connected to one third data sub-line 32c and inputs the second data signal to the one third data sub-line 32c. The second-type second control sub-line 62-22 supplies a low-level enable signal that turns on another one third sub-switch 11-2c in the second demultiplexer 10b. The left data terminal 20 in FIG. 9 is connected to another one third data sub-line 32c and inputs the second data signal to the another one third data sub-line 32c. Two third sub-switches 11-2c each are turned one once in this time period, so they are connected to different control lines and can be turned on in different time periods. The first-type first control sub-line 61-11 supplies a low-level enable signal that turns on one first sub-switch 11-a in the first demultiplexer 10a. The right data terminal 20 in FIG. 9 is connected to one first data sub-line 31a and inputs the first data signal to the one first data sub-line 31a. The first-type second control sub-line 61-12 supplies a low-level enable signal that turns on another one first sub-switch 11-1a in the first demultiplexer 10a. The right data terminal 20 in FIG. 9 is connected to another one first data sub-line 31a and inputs the first data signal to the another one first data sub-line 31a. Two first sub-switches 11-1a each are turned one once in this time period, so they are connected to different control lines and can be turned on in different time periods. In the time period Z1, the time duration of the low-level enable signal provided by the first-type first control sub-line 61-11 is equal to the time duration of the low-level enable signal provided by the first-type second control sub-line 61-12, and is longer than each of the time duration of the low-level enable signal provided by the second-type first control sub-line 62-21 and the time duration of the low-level enable signal provided by the second-type second control sub-line 62-22. As shown in FIG. 10, the time period during which the first-type first control sub-line 61-11 provides the low-level enable signal overlaps the time period during which the second-type first control sub-line 62-21 provides the low-level enable signal, and the time period during which the first-type second control sub-line 61-12 provides the low-level enable signal overlaps the time period during which the second-type second control sub-line 62-22 provides the low-level enable signal. In this way, the time consumed by inputting the row data signal is not too long, and the time duration for inputting the row data signal is equal to a sum of the turned-on time duration of two first switches 11.

With reference to the description of the time period Z1, in the time period Z2, two fourth sub-switches 11-2d in the second demultiplexer 10b each are turned on once, and two second sub-switches 11-1b in the first demultiplexer 10a each are turned on once. The operation of the demultiplexer in the time periods Z2 to Z4 can be understood with reference to the time period Z1 and is not described in details.

In this embodiment, the first demultiplexer 10a is connected to the first data line 31, and the second demultiplexer 10b is connected to the second data line 32. In the time period of inputting data signals to the odd-numbered pixel circuits in the first pixel circuit column 70L-1 and second pixel circuit column 70L-2, two first sub-switches 11-1a in the first demultiplexer 10a work, and two third sub-switches 11-2c in the second demultiplexer 10b work. In the time period of inputting data signals to the even-numbered pixel circuits in the first pixel circuit column 70L-1 and second pixel circuit column 70L-2, two second sub-switches 11-1b in the first demultiplexer 10a work in a time division manner, and two fourth sub-switches 11-2d in the second demultiplexer 10b work in a time division manner. In the first demultiplexer 10a, the turned-on time duration of the first sub-switch 11-1a and the turned-on time duration of the second sub-switch 11-1b can be controlled independently. By increasing the turned-on time durations of the first sub-switch 11-1a and the second sub-switch 11-1b, the first data line 31 can be charged more sufficiently, and thus the voltage required by the first sub-pixel 41 for switching to the dark state is reduced. Since the dark-state voltage of the display panel depends on the dark-state voltage of the first sub-pixel 41, the dark-state voltage of the display panel is reduced. For the display panel with reduced dark-state voltage, when the sub-pixel 40 driven by the data line 30 switches to the black greyscale, the line-to-line crosstalk between the data line 30 and other signal lines can be reduced, thereby improving the display effect.

In addition, in the driving method shown in FIG. 10, during the time period of inputting data signals to the odd-numbered pixel circuits in the first pixel circuit column 70L-1 and second pixel circuit column 70L-2, the turned-on time duration of the first sub-switch 11-1a and the turned-on time duration of the third sub-switch 11-2c have overlapping, and during the time period of inputting data signals to the even-numbered pixel circuits in the first pixel circuit column 70L-1 and second pixel circuit column 70L-2, the turned-on time duration of the second sub-switch 11-1b and the turned-on time duration of the fourth sub-switch 11-2d have overlapping. The turned-on time duration of the third sub-switch 11-2c is shorter than the turned-on time duration of the first sub-switch 11-1a, the turned-on time duration of the fourth sub-switch 11-2d is shorter than the turned-on time duration of the second sub-switch 11-1b, and the time duration of inputting the row data signal is determined by the turned-on time duration of the first sub-switch 11-1a and the turned-on time duration of the second sub-switch 11-1b. In the time period of inputting the row data signal, the first sub-switch 11-1a and the second sub-switch 11-1b in the demultiplexer each are turned on once in different time periods. Even the turned-on time durations of the first sub-switch 11-1a and the second sub-switch 11-1b are increased, the time duration of inputting the row data signal is not too long, ensuring that the time duration of inputting the row data signal cooperates with the scan line to meet the frame refresh time of the display panel.

In some embodiments, the driving method includes: the turned-on time duration of the switch 11 corresponding to the time period of inputting the first data signal to the input terminal of the demultiplexer 10 being the longest, the turned-on time duration of the switch 11 corresponding to the time period of inputting the second data signal to the input terminal of the demultiplexer 10 being T₀₂, the turned-on time duration of the switch 11 corresponding to the time period of inputting the third data signal to the input terminal of the demultiplexer 10 being T₀₃, and T₀₂-T₀₃. In this embodiment, the turned-on time duration of the switch 11 corresponding to the time period of inputting the first data signal is increased, the voltage value of the charged data line 30 is closer to the target voltage of the first data signal, so the voltage required by the first sub-pixel 41 for switching to the dark state is reduced. When the first sub-pixel 41 among the three sub-pixels emitting lights of different colors has a highest light-emitting efficiency, the dark-state voltage of the display panel depends on the dark-state voltage of the first sub-pixel 41. The dark-state voltage of the display panel can be reduced by the driving method provided by embodiments of the present disclosure. Conventionally, the three sub-pixels emitting lights of different colors are identical in the time duration of inputting the data signal, that is, the switch in the demultiplexer has a constant turned-on time duration in the time period of inputting the data signal to the data line. In embodiments of the present disclosure, the turned-on time duration of the switch when the first data signal is inputted is the longest, and the turned-on time duration of the switch when the second data signal is inputted is equal to the turned-on time duration of the switch when the third data signal is inputted. That is, only the time duration of inputting the data signal corresponding to the first sub-pixel 41 is increased, and the time duration of inputting the data signal corresponding to the second sub-pixel 42 and the time duration of inputting the data signal corresponding to the third sub-pixel 43 are not changed. Each pixel circuit row 70H is connected to sub-pixels emitting lights of different colors, so data voltages corresponding to sub-pixels emitting lights of different colors are inputted to the pixel circuit row 70H in the time period of inputting the row data signal. In the design of the demultiplexer 10, the time duration of inputting the row data signal is associated with the turned-on time duration of the switch in the demultiplexer 10. In embodiments of the present disclosure, the time durations of inputting the data signals corresponding to the second sub-pixel 42 and the third sub-pixel 43 are not changed, so the overall time duration of inputting the row data signal is just slightly affected by the increased turned-on time duration of the switch 11 connected to the first data line, and the time duration of inputting the row data signal cooperates with the scan line 80 to meet the frame refresh time of the display panel.

In addition, the turned-on time duration of the switch 11 when the second data signal is inputted is equal to the turned-on time duration of the switch 11 when the third data signal is inputted, thereby simplifying the control method of the demultiplexer 10. In some embodiments of the present disclosure, this configuration also reduces the number of control lines in the display panel. Accordingly, the number of pins of the display driving chip is reduced, and the manufacturing cost of the display driving chip is reduced.

In the example embodiment shown in FIG. 3, one second data line 32 is connected to multiple second sub-pixels 42 and multiple third sub-pixels 43, and the second data line 32 is connected to the second switch 11-2 in the demultiplexer 10. The second data signal corresponds to the second sub-pixel 42, and the third data signal corresponds to the third sub-pixel 43. During display, the turned-on time duration of the switch 11 when the second data signal is inputted is equal to the turned-on time duration of the switch 11 when the third data signal is inputted, so the control signal received by the control terminal of the second switch 11-2 is more regular. When the display panel works, the control terminal of the second switch 11-2 receives a regular control signal, and the time duration of the enable signal in the control signal is equal (for example, the second control signal K2 in FIG. 4), so the control signal is easy to obtain.

In the example embodiment shown in FIG. 5, the display panel includes two types of second data lines 32 including the third data sub-line 32c and the fourth data sub-line 32d. The third data sub-line 32c is connected to sub-pixels in an odd-numbered pixel circuit row, and the fourth data sub-line 32d is connected to sub-pixels in an even-numbered pixel circuit row. The third data sub-line 32c is connected to the third sub-switch 11-2c, and the fourth data sub-line 32d is connected to the fourth sub-switch 11-2d. FIG. 5 shows four pixel circuit columns, the first and third pixel circuit columns from left are connected to the second data lines 32, the odd-numbered sub-pixels in the first and third pixel circuit columns include second sub-pixels 32 and third sub-pixels 43, respectively. That is, in the first and third pixel circuit columns, the odd-numbered sub-pixels have different emission colors, and the even-numbered sub-pixels also have different emission colors. The second data signal corresponds to the second sub-pixel 42, and the third data signal corresponds to the third sub-pixel 43. During display, the turned-on time duration of the switch 11 when the second data signal is inputted is equal to the turned-on time duration of the switch 11 when the third data signal is inputted, and the connection manner shown in FIG. 5 can be implemented. That is, the third data sub-line 32c connected to the first pixel circuit column is connected to the third sub-switch 11-2c of one demultiplexer 10, the third data sub-line 32c connected to the third pixel circuit column is connected to the third sub-switch 11-2c of another one demultiplexer 10, and two third sub-switches 11-2c in two parallel demultiplexers 10 are connected to a same control line 60. In this way, the number of control lines in the display panel is reduced. Accordingly, the number of pins of the display driving chip is reduced, and the manufacturing cost of the display driving chip is reduced.

In some other embodiments, said supplying, by the data terminal 20, data signals to the input terminal of the demultiplexer 10 in step S101 includes the following step. The time duration of supplying by the data terminal 20 a first data signal to the input terminal of the demultiplexer 10 is t₁, the time duration of supplying by the data terminal 20 a second data signal to the input terminal of the demultiplexer 10 is t₂, and the time duration of supplying by the data terminal 20 a third data signal to the input terminal of the demultiplexer 10 is t₃, where t₁>t₂ and t₁>t₃.

FIG. 11 is a timing diagram of another display panel according to one or more embodiments of the present disclosure. The following description is made with an example in which the driving method in FIG. 11 is applied to the display panel in FIG. 5. FIG. 11 shows the timing of one data terminal 20 that supplies data signals. A high level indicates that the data terminal 20 supplies the first data signal, and a low level indicates that the data terminal 20 supplies the second data signal or the third data signal. FIG. 11 also shows signal timings of a first control sub-line 61-1, a second control sub-line 61-2, a third control sub-line 62-1, and a fourth control sub-line 62-2. The operation manner of the demultiplexer 10 controlled by these control lines can be understood with reference to the description of FIG. 6, which is not repeated herein. As shown in FIG. 11, t₁>t₂, and t₁>t₃.

In the driving method provided by embodiments of the present disclosure, the time period of inputting the first data signal to the data line 30 and the turned-on time duration of the switch 11 connected to this data line 30 are the longest, and the time period of inputting the second data signal or the third data signal to the data line 30 and the turned-on time duration of the corresponding switch 11 are shorter. In this way, the time duration of outputting the second data signal and the third data signal by the data terminal 20 can be reduced. With the overall time duration of inputting data signals to the data lines unchanged, the time duration of outputting the first data signal by the data terminal 20 can be increased. With the increased time duration of outputting the first data signal by the data terminal 20, the turned-on time duration of the switch 11 when the first data signal is inputted can be further increased, thereby further reducing the dark-state voltage of the display panel.

In some embodiments, if the time duration during which the data terminal 20 outputs the first data signal is increased, the time duration during which the data terminal 20 outputs the second data signal and the third data signal is reduced. For example, in the process of inputting the row data signal in the embodiment of FIG. 5, one data terminal 20 needs to output the first data signal and the second data signal (or the third data signal) in a time division manner. If the time duration of outputting the first data signal is increased, the time duration of outputting other data signal is reduced. With setting 1<t₁/t₂≤2, and 1<t₁/t₃≤2, the second data signal and the third data signal can be inputted adequately, thereby avoiding image distortion caused by insufficient charging.

In some embodiments, t₂=t₃. Only the time duration during which the data terminal 20 outputs the first data signal is adjusted, and the time duration during which the data terminal 20 outputs the second data signal is equal to the time duration during which the data terminal 20 outputs the third data signal, thereby simplifying the control method.

In some embodiments, as shown in FIG. 11, the low level of the first control sub-line 61-1 is used for turning on the switch 11 connected to the first data line 31, and the time duration of the low level of the first control sub-line 61-1 is the turned-on time duration of the switch 11 connected to the first data line 31 (namely, the turned-on time duration of the switch 11 corresponding to the time period of supplying the first data signal to the input terminal of the demultiplexer 10). The driving method provided by embodiments of the present disclosure includes: the time duration t₁ of supplying the first data signal by the data terminal 20 being longer than the turned-on time duration of the switch 11 corresponding to the time period in which the first data signal is supplied to the input terminal of the demultiplexer 10. This can ensure that the data terminal 10 continuously outputs the first data signal to the input terminal of the demultiplexer 10 when the first data signal is inputted to the data line. During the input of the first data signal, the turned-on time duration of the corresponding switch 11 is the effective input time, ensuring that the voltage value of the charged data line 30 is further closer to target voltage of the first data signal.

In some embodiments, as shown in FIG. 5 and FIG. 6, the driving method includes: supplying, by multiple data terminals 20, data signals to input terminals of multiple demultiplexers 10 respectively so as to input a row data signal to multiple data lines 30. The row data signal includes data signals required by multiple pixel circuits 70 in the pixel circuit row 70H. In the time period of inputting the row data signal to multiple data lines 30, the data terminal 20 outputs two data signals one by one to the input terminal of the demultiplexer 10, one data signal is the first data signal, and the other one data signal is the second data signal (or the third data signal). In the driving method provided by embodiments of the present disclosure, in the process of inputting the row data signal, one data terminal outputs only two data signals, one of which is the first data signal. If the time duration of inputting the row data signal is not changed, increasing the time duration of outputting the first data signal by the data terminal 20 has slight affecting on the time duration of outputting the other data signal, thereby avoiding image distortion caused by insufficient charging of other data signal.

Embodiments of the present disclosure further provide a display panel. The display panel may be driven by the driving method provided by any embodiment of the present disclosure. The display panel includes light-emitting elements, and the light-emitting elements may be organic light-emitting elements or inorganic light-emitting elements.

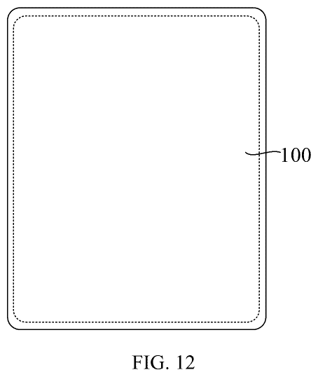

Embodiments of the present disclosure further provide a display device. FIG. 12 is a schematic diagram of a display device according to embodiments of the present disclosure. As shown in FIG. 12, the display device includes a display panel 100. The display panel 100 is driven by the driving method provided by any embodiment of the present disclosure. The driving method has been described in the above embodiments and is not repeated here. The display device provided in this embodiment of the present disclosure may be, for example, an electronic device such as a mobile phone, a computer, a tablet, and a television.

The above descriptions are merely preferred examples of the present disclosure, and are not intended to limit the present disclosure. Any modifications, equivalent replacements, improvements, and the like made within the spirit and principle of the present disclosure shall fall within the protection scope of the present disclosure.

Finally, it should be noted that the foregoing embodiments are merely intended to describe and not to limit the technical solutions of the present disclosure. Although the present disclosure has been described in detail with reference to the foregoing embodiments, persons skilled in the art should understand that they can still make modifications to the technical solutions described in the foregoing embodiments or make equivalent replacements to some or all of the technical features thereof. These modifications or replacements do not make the essence of the corresponding technical solutions deviate from the scope of the technical solutions of the embodiments of the present disclosure.

What is claimed is:

1. A method for driving a display panel,
wherein the display panel comprises a demultiplexer, a data terminal, data lines, and sub-pixels, the demultiplexer comprises an input terminal connected to the data terminal and output terminals connected to n data lines of the data lines respectively, n is an integer and n≥2, the demultiplexer further comprises n switches, each switch is connected between the input terminal and one of the output terminals and connected to a corresponding one data line of the n data lines, the data lines extend in a first direction and are connected to the sub-pixels, and the sub-pixels comprise a first sub-pixel, a second sub-pixel, and a third sub-pixel that emit lights of different colors,
wherein the method comprises:
supplying, by the data terminal, data signals to the input terminal of the demultiplexer, and turning on the switches for predetermined time durations respectively to input the data signals to the n data lines,
wherein the data signals comprise a first data signal corresponding to the first sub-pixel, a second data signal corresponding to the second sub-pixel, and a third data signal corresponding to the third sub-pixel; and wherein a turned-on time duration of the switch, which corresponds to a time period in which the first data signal is supplied to the input terminal of the demultiplexer, is the longest.

2. The method according to claim 1,
wherein the n data lines comprise first data lines and second data lines, one of the first data lines is connected to the first sub-pixel, and one of the second data lines is connected to at least one of the second sub-pixel or the third sub-pixel; and
wherein the turned-on time duration of the switch, which corresponds to a time period in which the first data signal is supplied to the input terminal of the demultiplexer, being the longest comprises: the turned-on time duration of the switch connected to the first data line being longer than the turned-on time duration of the switch connected to the second data line.

3. The method according to claim 2,
wherein the n switches comprise first switches connected to the first data lines, the display panel further comprises control lines connected to control terminals of the n switches, the control lines comprise first control lines, and the control terminals of the first switches are connected to a same one of the first control lines; and
wherein the method further comprises: supplying by the first control line an enable signal to simultaneously turn on the first switches connected to the first control line.

4. The method according to claim 3,
wherein the n switches comprise first switches connected to the second data lines, the control lines further comprise second control lines, the control terminals of the second switches are connected to a same one of the second control lines; and
wherein the method further comprises:
supplying, by the second control line, an enable signal to simultaneously turn on the second switches connected to the second control line, wherein a time duration of an active level of the enable signal supplied by the first control line is longer than a time duration of an active level of the enable signal supplied by the second control line.

5. The method according to claim 2,
wherein each of the sub-pixels comprises a pixel circuit, the pixel circuits are arranged in a second direction to define pixel circuit rows, and the second direction crosses the first direction;
wherein the data terminal comprises a plurality of data terminals, and the demultiplexer comprises a plurality of demultiplexers;
wherein the method further comprises: supplying, by the plurality of data terminals, data signals to the input terminals of the plurality of demultiplexers respectively, to input a row data signal to the data lines, wherein the row data signal comprises data signals required by the pixel circuits in the pixel circuit row, and in a time period of inputting the row data signal to the data lines, in each demultiplexer, the switch connected to the first data line and the switch connected to the second data line each are turned on once.

6. The method according to claim 2,
wherein the output terminals of the demultiplexer are connected to at least one first data line of the first data lines and at least one second data line of the second data lines, the switches comprise at least one first switch connected to the at least one first data line and at least one second switch connected to the at least one second data line, and
wherein the turned-on time duration of the switch, which corresponds to a time period in which the first data signal is supplied to the input terminal of the demultiplexer, being the longest comprises: sequentially supplying, by the data terminal, the data signals to the input terminal of the demultiplexer, and turning on the first switch and the second switch in the demultiplexer in different time periods, wherein the turned-on time duration of the first switch is longer than the turned-on time duration of the second switch.

7. The method according to claim 6,
wherein each of the sub-pixels comprises a pixel circuit, the pixel circuits in the first sub-pixels are arranged in the first direction to define a first pixel circuit column, the pixel circuits in the second sub-pixels and the pixel circuits in the third sub-pixels are alternately arranged in the first direction to define a second pixel circuit column;
wherein the first data lines comprise a first data sub-line and a second data sub-line, the first data sub-line is connected to odd-numbered pixel circuits in the first pixel circuit column, and the second data sub-line is connected to even-numbered pixel circuits in the first pixel circuit column; and the first switch comprises a first sub-switch connected to the first data sub-line and a second sub-switch connected to the second data sub-line;
wherein the second data lines comprise a third data sub-line and a fourth data sub-line, the third data sub-line is connected to odd-numbered pixel circuits in the second pixel circuit column, and the fourth data sub-line is connected to even-numbered pixel circuits in the second pixel circuit column; and the second switch comprises a third sub-switch connected to the third data sub-line and a fourth sub-switch connected to the fourth data sub-line;
wherein the demultiplexer comprises the first sub-switch, the second sub-switch, the third sub-switch, and the fourth sub-switch;
wherein the turning on the first switch and the second switch in the demultiplexer in different time periods comprises: alternately turning on the first switch and the second switch in the demultiplexer;
wherein in a time period of inputting data signals to the odd-numbered pixel circuits in the first pixel circuit column and the second pixel circuit column, the first sub-switch and the third sub-switch are turned on in different time periods, and the turned-on time duration of the first sub-switch is longer than the turned-on time duration of the third sub-switch; and
wherein in a time period of inputting data signals to the even-numbered pixel circuits in the first pixel circuit column and the second pixel circuit column, the second sub-switch and the fourth sub-switch are turned on in different time periods, and the turned-on time duration of the second sub-switch is longer than the turned-on time duration of the fourth sub-switch.

8. The method according to claim 6,
wherein each of the sub-pixels comprises a pixel circuit, the pixel circuits in the first sub-pixels are arranged in the first direction to define a first pixel circuit column, the pixel circuits in the second sub-pixels and the pixel circuits in the third sub-pixels are alternately arranged in the first direction to define a second pixel circuit column;
wherein the first data line is connected to the pixel circuits in the first pixel circuit column, the second data line is connected to the pixel circuits in the second pixel circuit column, and the output terminals of the demultiplexer are connected to one first data line and one second data line; and
wherein the sequentially supplying, by the data terminal, the data signals to the input terminal of the demultiplexer, and turning on the first switch and the second switch in the demultiplexer in different time periods comprises:
in a time period of supplying, by the data terminal, the first data signal to the input terminal of the demultiplexer, turning on the first switch to input the first data signal to the first data line; and
in a time period of supplying, by the data terminal, the second data signal to the input terminal of the demultiplexer, turning on the second switch to input the second data signal to the second data line; and
in a time period of supplying, by the data terminal, the third data signal to the input terminal of the demultiplexer, turning on the second switch to input the third data signal to the second data line.

9. The method according to claim 2,
wherein the demultiplexer comprises a first demultiplexer and a second demultiplexer, the switches comprise first switches connected to the first data lines and second switches connected to the second data lines, the first demultiplexer comprises the first switches, the second demultiplexer comprises the second switches, the output terminals of the first demultiplexer are connected to at least two first data lines, and the output terminals of the second demultiplexer are connected to at least two second data lines; and
wherein the turned-on time duration of the switch, which corresponds to a time period in which the first data signal is supplied to the input terminal of the demultiplexer, being the longest further comprises:
supplying, by the data terminal, data signals to the input terminal of first the demultiplexer, and turning on the first switches in the first demultiplexer in different time periods; and
supplying, by the data terminal, data signals to the input terminal of the second demultiplexer, and turning on the second switches in the second demultiplexer in different time periods, wherein the turned-on time duration of the first switch is longer than the turned-on time duration of the second switch.

10. The method according to claim 9,
wherein each of the sub-pixels comprises a pixel circuit, the pixel circuits in the first sub-pixels are arranged in the first direction to define a first pixel circuit column, the pixel circuits in the second sub-pixels and the pixel circuits in the third sub-pixels are alternately arranged in the first direction to define a second pixel circuit column;
wherein the at least two first data lines comprise a first data sub-line and a second data sub-line, the first data sub-line is connected to odd-numbered pixel circuits in the first pixel circuit column, and the second data sub-line is connected to even-numbered pixel circuits in the first pixel circuit column; and the first switches comprise a first sub-switch connected to the first data sub-line and a second sub-switch connected to the second data sub-line;
wherein the at least two second data lines comprise a third data sub-line and a fourth data sub-line, the third data sub-line is connected to odd-numbered pixel circuits in the second pixel circuit column, and the fourth data sub-line is connected to even-numbered pixel circuits in the second pixel circuit column; and the second switches comprise a third sub-switch connected to the third data sub-line and a fourth sub-switch connected to the fourth data sub-line,
the first switches in the first demultiplexer comprise two first sub-switches and two second sub-switches, and the second switches in the second demultiplexer comprise two third sub-switches and two fourth sub-switches,
wherein the turning on the first switches in the first demultiplexer in different time periods comprises: in a time period of inputting data signals to the odd-numbered pixel circuits in the first pixel circuit column, turning on the two first sub-switches in different time periods; and in a time period of inputting data signals to the even-numbered pixel circuits in the first pixel circuit column, turning on the two second sub-switches in different time periods, and
wherein the turning on the second switches in the second demultiplexer in different time periods comprises: in a time period of inputting data signals to the odd-numbered pixel circuits in the second pixel circuit column, turning on the two third sub-switches in different time periods; and in a time period of inputting data signals to the even-numbered pixel circuits in the second pixel circuit column, turning on the two fourth sub-switches in different time periods.

11. The method according to claim 1, wherein the turned-on time duration T₀₂ of the switch, which corresponds to a time period in which the second data signal is supplied to the input terminal of the demultiplexer, is equal to the turned-on time duration T₀₃ of the switch, which corresponds to a time period in which the third data signal is supplied to the input terminal of the demultiplexer.

12. The method according to claim 1, wherein the supplying, by the data terminal, data signals to the input terminal of the demultiplexer comprises: a time duration t₁ in which the data terminal supplies the first data signal to the input terminal of the demultiplexer, a time duration t₂ in which the data terminal supplies the second data signal to the input terminal of the demultiplexer, and a time duration t₃ in which the data terminal supplies the third data signal to the input terminal of the demultiplexer satisfying: t₁>t₂, and t₁>t₃.

13. The method according to claim 12, wherein t₂=t₃.

14. The method according to claim 12, wherein the turned-on time duration of the switch, which corresponds to the time period in which the first data signal is supplied to the input terminal of the demultiplexer, is T₀₁, and t₁ is longer than T₀₁.

15. The method according to claim 12, wherein each of the sub-pixels comprises a pixel circuit, the pixel circuits are arranged in a second direction to define pixel circuit rows, and the second direction crosses the first direction,
the data terminal comprises a plurality of data terminals, and the demultiplexer comprises a plurality of demultiplexers,
the method further comprises: supplying, by the plurality of data terminals, data signals to the input terminals of the plurality of demultiplexers to input a row data signal to the data lines, wherein the row data signal comprises data signals required by the pixel circuits in the pixel circuit row,
wherein in a time period of inputting the row data signal to the data lines, the data terminal supplies two data signals to the input terminal of the demultiplexer, one of the two data signals is the first data signal, and the other one of the two data signals is the second data signal or the third data signal.

16. The method according to claim 12, wherein 1<t₁/t₂≤2, and 1<t₁/t₃≤2.

17. The method according to claim 1, wherein the first sub-pixel is a green sub-pixel.

18. A display panel driven by a method,
wherein the display panel comprises a demultiplexer, a data terminal, data lines, and sub-pixels, the demultiplexer comprises an input terminal connected to the data terminal and output terminals connected to n data lines of the data lines respectively, n is an integer and n≥2, the demultiplexer further comprises n switches, each switch is connected between the input terminal and one of the output terminals and connected to a corresponding one data line of the n data lines, the data lines extend in a first direction and are connected to the sub-pixels, and the sub-pixels comprise a first sub-pixel, a second sub-pixel, and a third sub-pixel that emit lights of different colors,
wherein the method comprises:
supplying, by the data terminal, data signals to the input terminal of the demultiplexer, and turning on the switches for predetermined time durations respectively to input the data signals to the n data lines,
wherein the data signals comprise a first data signal corresponding to the first sub-pixel, a second data signal corresponding to the second sub-pixel, and a third data signal corresponding to the third sub-pixel; and wherein a turned-on time duration of the switch, which corresponds to a time period in which the first data signal is supplied to the input terminal of the demultiplexer, is the longest.

19. A display device comprising a display panel driven by a method,
wherein the display panel comprises a demultiplexer, a data terminal, data lines, and sub-pixels, the demultiplexer comprises an input terminal connected to the data terminal and output terminals connected to n data lines of the data lines respectively, n is an integer and n≥2, the demultiplexer further comprises n switches, each switch is connected between the input terminal and one of the output terminals and connected to a corresponding one data line of the n data lines, the data lines extend in a first direction and are connected to the sub-pixels, and the sub-pixels comprise a first sub-pixel, a second sub-pixel, and a third sub-pixel that emit lights of different colors,
wherein the method comprises:
supplying, by the data terminal, data signals to the input terminal of the demultiplexer, and turning on the switches for predetermined time durations respectively to input the data signals to the n data lines,
wherein the data signals comprise a first data signal corresponding to the first sub-pixel, a second data signal corresponding to the second sub-pixel, and a third data signal corresponding to the third sub-pixel; and wherein a turned-on time duration of the switch, which corresponds to a time period in which the first data signal is supplied to the input terminal of the demultiplexer, is the longest.
